(19) United States
(12) Patent Application Publication
(10) Pub. No.: US 2026/0337352 A1
(43) Pub. Date: Oct. 29, 2026

(54) RECYCLABLE AND READILY WASHABLE LOW-DENSITY LABEL AND RECOVERY METHOD THEREFOR

(71) Applicant: HENAN YINJINDA NEW MATERIALS CO., LTD., Xinxiang (CN)

(72) Inventors: Qigang ZHANG, Xinxiang (CN); Yinfeng YAN, Xinxiang (CN); Yuanhong LI, Xinxiang (CN); Qi WU, Xinxiang (CN); Pengpeng FAN, Xinxiang (CN); Wenbin CAI, Xinxiang (CN); Hailiang LI, Xinxiang (CN); Lin YUAN, Xinxiang (CN); Yufeng SUN, Xinxiang (CN); Jiaojiao CHEN, Xinxiang (CN); Penghui LI, Xinxiang (CN)

(73) Assignee: HENAN YINJINDA NEW MATERIALS CO., LTD., Xinxiang (CN)

(21) Appl. No.: 19/703,141

(22) Filed: Jun. 10, 2026

Related U.S. Application Data
(63) Continuation of application No. PCT/CN2025/140341, filed on Dec. 5, 2025.

(30) Foreign Application Priority Data
Feb. 27, 2025 (CN) 2025102213104

(51) Int. Cl. C08J 7/04; B09B 3/35; B09B 3/38; B09B 101/75; C08G 77/26; C09D 7/20; C09D 7/80; C09D 183/08; G09F 3/00; G09F 3/02

(52) U.S. Cl. CPC C08J 7/0427; B09B 3/35; B09B 3/38; C08G 77/26; C09D 7/20; C09D 7/80; C09D 183/08; G09F 3/0291; B09B 2101/75; C08J 2483/08; G09F 2003/0222; G09F 2003/0223; G09F 2003/0273

(57) ABSTRACT

A recyclable and readily washable low-density label and a recovery method therefor are disclosed, the recyclable and readily washable low-density label is prepared by surface-modifying a low-density heat-shrinkable film with a surface modifier; the density of the low-density heat-shrinkable film is less than 0.96 g/cm³; the surface modifier is prepared via a sol-gel process using tetraethyl orthosilicate, N-[2-(benzylamino)ethyl]-3-aminopropyltrimethoxysilane, and acetoxyethyltrimethoxysilane. In the present application, the surface-modified label not only improves ink adhesion and stability on its surface but also enables rapid separation of the label via simple flotation during recovery, and allows effective washing of the ink from the label in a washing solution, thereby enhancing ink removal efficiency and achieving impurity-free label recovery.

### CROSS-REFERENCE TO RELATED APPLICATIONS

This application claims the priority of a Chinese patent application filed on 27 Feb. 2025 with the China National Intellectual Property Administration, having application number CN202510221310.4 and entitled “RECYCLABLE AND READILY WASHABLE LOW-DENSITY LABEL AND RECOVERY METHOD THEREFOR”, the entire contents of which are incorporated herein by reference.

### TECHNICAL FIELD

The present application relates to the technical field of shrink film processing, and particularly to a recyclable and readily washable low-density label and a recovery method therefor.

### BACKGROUND

Labels are commonly used in packaging materials for various food and daily consumer products, primarily as shrink sleeves, full-wrap labels, bottle caps, and cap seals. Compared with traditional label materials, label films exhibit superior conformability, higher transparency, and enhanced visual presentation of packaged goods; they also possess excellent strength and abrasion resistance, and have been widely adopted across diverse application fields in recent years.

Label films typically employ heat-shrinkable films as the primary material. Heat-shrinkable films offer favorable properties such as high gloss, excellent conformability, and strong shrinkability. Moreover, their gloss and shrinkability render packaging graphics on containers more vivid and enhance shelf visibility in supermarkets, producing an unexpected “shelf-effect”, thus enabling broad application in container packaging.

Conventional heat-shrinkable films for labels mainly include polyvinyl chloride (PVC), poly(ethylene terephthalate-co-1,4-cyclohexanedimethanol terephthalate) (PETG), and oriented polystyrene (OPS). PVC heat-shrinkable film exhibits high tensile strength, large elongation, good self-adhesion, and high transparency; however, it generates highly toxic dioxins during recovery and suffers from poor environmental compatibility, leading to its progressive prohibition; OPS heat-shrinkable film features high strength, high rigidity, dimensional stability, and excellent gloss and transparency; it is easy to process, readily colorable, offers superior printability and very high printing resolution, and is cost-effective. PETG heat-shrinkable film is non-toxic, odorless, possesses high strength, high thermal shrinkage, excellent optical properties, mechanical extensibility, and aesthetically pleasing packaging performance, thereby driving rapid growth in the adoption of both OPS and PETG heat-shrinkable films.

However, both PVC and OPS heat-shrinkable films suffer from high density. In subsequent recovery processes, when polyethylene terephthalate (PET) bottles, containers with density greater than that of water, and PETG or OPS heat-shrinkable films are shredded and subjected to flotation using water as the flotation medium, both the PET bottle material and the PETG or OPS heat-shrinkable film sink, rendering separation between the PET bottle material and the PETG and/or OPS heat-shrinkable film extremely difficult. If PETG and/or OPS heat-shrinkable film contaminants are introduced into the PET bottle material during recovery, the quality of the recovered container material is compromised, rendering it unsuitable for reprocessing via blow molding, thereby adversely affecting the recyclability of high-density container materials such as PET bottles.

Meanwhile, the adhesion performance and stability of ink on labels in the prior art still require improvement; the printed ink cannot be maintained for a long time under humid conditions and cannot be rapidly and cleanly removed during recovery, thereby affecting the quality of recycled materials.

Accordingly, there is an urgent need for a low-density label that improves ink adhesion and enables impurity-free recovery after flotation and washing.

### SUMMARY

To overcome the problems existing in the prior art, the present application provides a recyclable and readily washable low-density label, which is prepared by surface-modifying a low-density heat-shrinkable film with a surface modifier, and a recovery method therefor, wherein the label improves ink adhesion and enables impurity-free recovery after flotation and washing.

The present application provides a recyclable and readily washable low-density label, which is prepared by surface-modifying a low-density heat-shrinkable film with a surface modifier;
the density of the low-density heat-shrinkable film is less than 0.96 g/cm³;
the surface modifier is prepared via a sol-gel reaction of tetraethyl orthosilicate, N-[2-(benzylamino)ethyl]-3-aminopropyltrimethoxysilane, and acetoxyethyltrimethoxysilane.

In the present application, by controlling the density of the heat-shrinkable film to be less than 0.96 g/cm³, the film, after pulverization, floats on the water surface, enabling flotation separation from other components based on density differences; this separation process is simple, efficient, and suitable for large-scale recovery operations.

Further, the surface modifier is prepared as follows:
(1) in a reactor, adding tetraethyl orthosilicate, p-toluenesulfonic acid, and anhydrous ethanol and stirring uniformly to form solution a;
(2) in a reactor, adding N-[2-(benzylamino)ethyl]-3-aminopropyltrimethoxysilane, acetoxyethyltrimethoxysilane, and anhydrous ethanol and stirring uniformly to form solution b;
(3) in the reactor, adding solution a and solution b, raising the temperature to 40-50 °C, and stirring the mixture for 4-6 hours; cooling to obtain the surface modifier.

On one hand, the surface modifier of the present application, being in sol-gel form, has a uniform particle size, enabling uniform grafting onto the pretreated heat-shrinkable film surface; this improves the surface flatness of the heat-shrinkable film, allowing ink with a uniform particle size to fully fill the surface and preventing occupation by air or other components, thereby increasing the ink's adhesion area and enhancing adhesion performance; on the other hand, its polyamino and benzene ring structure forms a stable network on the heat-shrinkable film surface, which not only prevents moisture intrusion under humid conditions but also enhances the ink's lightfastness; moreover, this network structure rapidly decomposes under the action of aqueous washing solution, enabling rapid ink removal during washing.

Further, in solution a, the mass ratio of tetraethyl orthosilicate, p-toluenesulfonic acid, and anhydrous ethanol is (15-20):(1-2):(35-50).

Further, in solution b, the mass ratio of N-[2-(benzylamino)ethyl]-3-aminopropyltrimethoxysilane, acetoxyethyltrimethoxysilane, and anhydrous ethanol is (10-12):(6-8):(35-50).

Further, in step (3), the mass ratio of solution a to solution b is (6-8):(4-5).

Further, the recyclable and readily washable low-density label is prepared as follows:
(1) in a reactor, adding potassium permanganate and deionized water; after stirring uniformly, slowly adding concentrated sulfuric acid; heating the mixture to 35-40 °C, then adding a low-density heat-shrinkable film; after stirring and reacting for 10-15 minutes, removing the low-density heat-shrinkable film and washing to complete pretreatment;
(2) immersing the pretreated low-density heat-shrinkable film in the surface modifier, stirring and reacting for 30-45 minutes, washing, and drying to obtain the recyclable and readily washable low-density label.

In the present application, oxidation pretreatment of the label material using potassium permanganate and concentrated sulfuric acid not only enables effective grafting of the surface modifier onto the heat-shrinkable film surface but also modifies the surface uniformity, ensuring uniform adhesion of the surface modifier to the heat-shrinkable film surface.

Further, the mass fraction of concentrated sulfuric acid in step (1) is 90-98 wt %; the mass ratio of potassium permanganate, concentrated sulfuric acid, and deionized water is (5-8):(1-2):(80-90).

A recovery method for any of the recyclable and readily washable low-density labels recited above, including the following steps:
(1) crushing: crushing a bottle body containing the recyclable and readily washable low-density label;
(2) flotation: placing the crushed material in an aqueous solution containing a surfactant, and after stirring and shaking, causing the recyclable and readily washable low-density label to float on the water surface;
(3) washing: transferring the recyclable and readily washable low-density label into the washing solution, raising the temperature to 35-40 °C, stirring for 15-20 minutes, then filtering, washing, and drying to realize the recovery of the recyclable and readily washable low-density label.

Further, the surfactant in step (2) is selected from one of ethylene-bis(dodecyldimethylammonium chloride), propylene-bis(hexadecyldimethylammonium bromide), or ethylene-bis(octadecyldimethylammonium chloride); the surfactant is added in an amount of 0.3-1 wt % based on the mass of water.

In the present application, adding a surfactant to the water during flotation disrupts the surface tension between each component and water, thereby reducing the flotation of higher-density materials on the water surface caused by adhered air bubbles or surface tension, and thus improving the flotation recovery efficiency of the label.

Further, the washing solution in step (3) is prepared by mixing ethyl acetate, pentaerythritol, cocamidopropyl betaine, triethanolamine, and deionized water.

Advantageous effects of the present application:

(1) The recyclable and readily washable low-density label provided herein is fabricated by surface modification of a low-density heat-shrinkable film using a surface modifier. The surface-modified label not only enhances ink adhesion and stability on its surface but also enables rapid separation via simple flotation during recovery, and allows effective removal of ink in the washing solution, thereby improving ink washing efficiency and achieving impurity-free label recovery.

(2) The recyclable and readily washable low-density label provided herein has a heat-shrinkable film density controlled to be less than 0.96 g/cm³, enabling the crushed fragments to float on the water surface and undergo flotation separation from other components based on density differences. This separation process is simple, efficient, and suitable for large-scale recovery operations.

(3) The recovery method for the recyclable and readily washable low-density label provided herein improves flotation recovery efficiency by adding a surfactant to the water during flotation, thereby disrupting the surface tension between each component and water and minimizing the flotation of relatively high-density materials due to adhered air bubbles or surface tension.

(4) The recyclable and readily washable low-density label provided in this application employs a surface modifier prepared via the sol-gel process using tetraethyl orthosilicate, N-[2-(benzylamino)ethyl]-3-aminopropyltrimethoxysilane, and acetoxyethyltrimethoxysilane. On one hand, the sol-gel-derived surface modifier exhibits uniform particle size, enabling homogeneous grafting onto the pretreated heat-shrinkable film surface, thereby improving the surface flatness of the film. This allows ink with uniform particle size to fully fill the film surface and prevents void formation (e.g., air entrapment), thereby increasing the ink adhesion area and enhancing ink adhesion performance; on the other hand, its polyamino and benzene ring structure forms a stable network on the heat-shrinkable film surface, which not only prevents moisture intrusion under humid conditions but also enhances the ink's lightfastness; moreover, this network structure rapidly decomposes under the action of aqueous washing solution, enabling rapid ink removal during washing.

(5) In the recyclable and readily washable low-density label provided in the present application, oxidation pretreatment of the label material with potassium permanganate and concentrated sulfuric acid not only enables effective grafting of the surface modifier onto the surface of the heat-shrinkable film, but also improves surface uniformity, thereby ensuring uniform adhesion of the surface modifier to the surface of the heat-shrinkable film.

### DETAILED DESCRIPTION OF THE EMBODIMENTS

The present application will now be described with reference to specific embodiments. It is to be understood that the following examples are illustrative of the present application only and are not intended to limit the scope of the present application. Other combinations and modifications within the concept of the present application may be made without departing from the spirit or scope thereof.

CAS No. of N-[2-(benzylamino)ethyl]-3-aminopropyltrimethoxysilane is 209866-89-7; the low-density heat-shrinkable film was prepared according to the method disclosed in patent CN202311725243.7; commercially available silica sol (JN-30) was purchased from Yuanyang County Lutong Refractory Materials Co., Ltd.; commercially available washing solution was No. 120 solvent oil purchased from Changzhou Aozun Composite New Materials Co., Ltd.; all other reagents and equipment were conventional reagents and equipment in the art.

### Preparation of Surface Modifier-1

Surface modifier-1 was prepared by the following steps: in parts by weight,
(1) In a reactor, 1.5 parts of tetraethyl orthosilicate, 0.1 part of p-toluenesulfonic acid, and 5 parts of anhydrous ethanol were added and stirred uniformly to form solution a;
(2) In a reactor, 1 part of N-[2-(benzylamino)ethyl]-3-aminopropyltrimethoxysilane, 0.8 part of acetoxyethyltrimethoxysilane, and 5 parts of anhydrous ethanol were added and stirred uniformly to form solution b;
(3) In a reactor, 8 parts of solution a and 5 parts of solution b were added, the temperature was raised to 50 °C, and the mixture was stirred for 4 hours; after cooling, Surface modifier-1 was obtained.

### Preparation of Surface Modifier-2

Surface modifier-2 was prepared substantially as described for Surface modifier-1, except that N-[2-(benzylamino)ethyl]-3-aminopropyltrimethoxysilane was replaced with an equimolar amount of acetoxyethyltrimethoxysilane.

### Example 1

A recyclable and readily washable low-density label was prepared by the following steps, in parts by weight,
(1) In a reactor, 0.5 part of potassium permanganate and 9 parts of deionized water were added; after stirring uniformly, 0.2 part of concentrated sulfuric acid with a mass fraction of 98 wt % was slowly added; the mixture was heated to 40 °C, then a low-density heat-shrinkable film was added; after stirring and reacting for 15 minutes, the low-density heat-shrinkable film was removed and washed to complete the pretreatment;
(2) The pretreated low-density heat-shrinkable film is immersed in surface modifier-1, stirred and reacted for 30 minutes, then washed and dried to obtain the recyclable and readily washable low-density label;
the density of the low-density heat-shrinkable film was 0.93 g/cm³;
the recovery of the recyclable and readily washable low-density label was performed as follows:
(1) crushing: crushing a bottle body containing the recyclable and readily washable low-density label;
(2) flotation: the crushed material was placed in an aqueous solution containing 0.5 wt % ethylene-bis(dodecyldimethylammonium chloride); after stirring and shaking, the recyclable and readily washable low-density label floated on the water surface;
(3) washing: the recyclable and readily washable low-density label was transferred into the washing solution, heated to 35 °C, stirred for 20 minutes, then filtered, washed, and dried to recover the recyclable and readily washable low-density label;

The washing solution was prepared by mixing 10 wt % ethyl acetate, 5 wt % pentaerythritol, 1.5 wt % cocamidopropyl betaine, 3.5 wt % triethanolamine, and 80 wt % deionized water.

### Example 2

Substantially as described in Example 1, except that the density of the low-density heat-shrinkable film was 0.95 g/cm³; in the flotation process, ethylene-bis(dodecyldimethylammonium chloride) was replaced with an equimolar amount of propylene-bis(hexadecyldimethylammonium bromide).

### Example 3

Substantially as described in Example 1, except that the density of the low-density heat-shrinkable film was 0.92 g/cm³; ethylene-bis(dodecyldimethylammonium chloride) was replaced with an equimolar amount of ethylene-bis(octadecyldimethylammonium chloride) in the flotation process.

### Comparative Example 1

Substantially the same as the recovery step of Example 1, except that the recyclable and readily washable low-density label was not prepared, and a PET heat-shrinkable film was used instead.

### Comparative Example 2

Substantially the same as Example 1, except that surface modifier-1 in the preparation of the recyclable and readily washable low-density label was replaced with an equivalent amount of commercially available silica sol.

### Comparative Example 3

Substantially the same as Example 1, except that surface modifier-1 in the preparation of the recyclable and readily washable low-density label was replaced with an equivalent amount of surface modifier-2.

### Comparative Example 4

Substantially the same as Example 1, except that ethylene-bis(dodecyldimethylammonium chloride) was not added in the recovery step (2).

### Comparative Example 5

Substantially the same as Example 1, except that the washing solution in the recovery step (3) was replaced with an equivalent amount of commercially available washing solution.

### Performance Testing

Ink adhesion test: according to GB/T 9286-2021, Cross-cut Test for Paints and Varnishes, the PET heat-shrinkable films from Examples 1-3 and Comparative example 1, and the label films from Comparative examples 2-3 were printed with conventional water-based inks, and ink adhesion grade −1 was measured.

Humidity-heat resistance test: after being stored for 144 h in an environment at 45 °C and 98% relative humidity, the PET heat-shrinkable films from Examples 1-3 and Comparative example 1, and the label films from Comparative examples 2-3 were retested for adhesion grade −2 according to GB/T 9286-2021.

Light resistance test: after being exposed for 36 h under irradiation at a wavelength of 420 nm, a temperature of 40 °C, and an irradiance of 1.5 W/m², the PET heat-shrinkable films from Examples 1-3 and Comparative example 1, and the label films from Comparative examples 2-3 were retested for adhesion grade −3 according to GB/T 9286-2021.

The test results are shown in the table below:

| | Adhesion | Adhesion | Adhesion |
|---|---|---|---|
| | grade −1 | grade −2 | grade −3 |
| Example 1 | 0 | 0 | 1 |
| Example 2 | 0 | 0 | 1 |
| Example 3 | 0 | 0 | 1 |
| Comparative | 1 | 3 | 2 |
| example 1 | | | |
| Comparative | 1 | 2 | 2 |
| example 2 | | | |
| Comparative | 0 | 1 | 1 |
| example 3 | | | |

Comparison of the test results between Examples 1-3 and Comparative example 1 shows that the recyclable and readily washable low-density label provided herein exhibits superior ink adhesion compared with conventional label materials, and improves the humidity-heat resistance and light resistance of the ink, thereby enhancing printing performance and stability.

Comparison of the test results between Examples 1-3 and Comparative examples 2-3 shows that modification of the recyclable and readily washable low-density label with a surface modifier significantly enhances ink adhesion and stability, thereby extending its service life.

Recovery efficiency test: the flotation efficiency of the labels in Examples 1-3 and Comparative examples 1-5, as well as the impurity content (including ink), was measured and recorded. The flotation efficiency test method is as follows: 1000 labeled bottles were selected; the total weight of the labels thereon (denoted as W1) was determined. The bottles were cleaned using a bottle flake recycling and regeneration system, then crushed and subjected to flotation according to the method described in the respective example or comparative example. The resulting bottle flakes were collected, and any unseparated labels were screened out, collected, and weighed (denoted as W2). Flotation efficiency (%) was calculated using the formula: “Flotation efficiency (%)=1−W2/W1”; the impurity content test method is as follows: ten full-printed label samples, each measuring 10×10 cm, were randomly selected. After washing according to the method described in the respective example or comparative example, each sample was placed on coordinate paper (1×1 mm grid). The number of grid squares containing ink (a grid square is counted if the proportion of ink-covered area exceeds 50%/; otherwise, it is disregarded) was recorded as N1. The impurity content of each sample was calculated as N1/100, and the average impurity content across the ten samples was taken as the final impurity content.

The test results are shown in the table below:

| | Flotation | Impurity |
|---|---|---|
| | efficiency | content |
| | (%) | (%) |
| Example 1 | 98.7 | 0.17 |
| Example 2 | 98.5 | 0.18 |
| Example 3 | 99.0 | 0.15 |
| Comparative | 74.3 | 4.77 |
| example 1 | | |
| Comparative | 96.8 | 0.58 |
| example 2 | | |
| Comparative | 97.6 | 0.34 |
| example 3 | | |
| Comparative | 92.7 | 0.22 |
| example 4 | | |
| Comparative | 98.7 | 1.45 |
| example 5 | | |

Comparison of the examination results of Examples 1-3 with those of Comparative example 1 shows that the recyclable and readily washable low-density label and the associated recovery method disclosed herein exhibit superior flotation and washing performance relative to conventional label materials, enabling effective impurity-free recovery of the label material and enhancing its practical applicability.

Comparison of the test results of Examples 1-3 with those of Comparative examples 2-3 shows that the recyclable and readily washable low-density label and the associated recovery method disclosed herein improve the washing efficacy of the washing solution on the ink and reduce the impurity content by modifying the label material with a surface modifier.

Comparison of the test results of Examples 1-3 with those of Comparative examples 4-5 shows that the recyclable and readily washable low-density label and the associated recovery method disclosed herein enhance the flotation and washing performance of the label by adding a surfactant during flotation and using a washing solution with a specific composition during washing.

The foregoing embodiments are provided solely to illustrate the technical concept and features of the present application. Their purpose is to enable persons skilled in the art to understand the disclosed content and implement it accordingly. They shall not be construed as limiting the scope of protection of the present application. Equivalent modifications or adaptations made in accordance with the essential spirit of the present application shall fall within the scope of protection defined by the claims.

What is claimed is:

1. A recyclable and readily washable low-density label, wherein the recyclable and readily washable low-density label is prepared by surface-modifying a low-density heat-shrinkable film with a surface modifier;
the density of the low-density heat-shrinkable film is less than 0.96 g/cm³;
the surface modifier is prepared via a sol-gel reaction of tetraethyl orthosilicate, N-[2-(benzylamino)ethyl]-3-aminopropyltrimethoxysilane, and acetoxyethyltrimethoxysilane.

2. The recyclable and readily washable low-density label according to claim 1, wherein the surface modifier is prepared by the following steps:
(1) in a reactor, adding tetraethyl orthosilicate, p-toluenesulfonic acid, and anhydrous ethanol and stirring uniformly to form solution a;
(2) in a reactor, adding N-[2-(benzylamino)ethyl]-3-aminopropyltrimethoxysilane, acetoxyethyltrimethoxysilane, and anhydrous ethanol and stirring uniformly to form solution b;
(3) in the reactor, adding solution a and solution b, raising the temperature to 40-50 °C, and stirring the mixture for 4-6 hours; cooling to obtain the surface modifier.

3. The recyclable and readily washable low-density label according to claim 2, wherein the mass ratio of tetraethyl orthosilicate, p-toluenesulfonic acid, and anhydrous ethanol in solution a is (15-20):(1-2):(35-50).

4. The recyclable and readily washable low-density label according to claim 2, wherein the mass ratio of N-[2-(benzylamino)ethyl]-3-aminopropyltrimethoxysilane, acetoxyethyltrimethoxysilane, and anhydrous ethanol in solution b is (10-12):(6-8):(35-50).

5. The recyclable and readily washable low-density label according to claim 2, wherein the mass ratio of solution a to solution b in step (3) is (6-8):(4-5).

6. The recyclable and readily washable low-density label according to claim 1, wherein the recyclable and readily washable low-density label is prepared by the following steps:
(1) in a reactor, adding potassium permanganate and deionized water; after stirring uniformly, slowly adding concentrated sulfuric acid; heating the mixture to 35-40 °C, then adding a low-density heat-shrinkable film; after stirring and reacting for 10-15 minutes, removing the low-density heat-shrinkable film and washing to complete pretreatment;
(2) immersing the pretreated low-density heat-shrinkable film in the surface modifier, stirring and reacting for 30-45 minutes, washing, and drying to obtain the recyclable and readily washable low-density label.

7. The recyclable and readily washable low-density label according to claim 6, wherein the mass fraction of concentrated sulfuric acid in step (1) is 90-98 wt %; the mass ratio of potassium permanganate, concentrated sulfuric acid, and deionized water is (5-8):(1-2):(80-90).

8. A recovery method for the recyclable and readily washable low-density label according to claim 1, comprising the following steps:
(1) crushing: crushing a bottle body containing the recyclable and readily washable low-density label;
(2) flotation: placing the crushed material in an aqueous solution containing a surfactant, and after stirring and shaking, causing the recyclable and readily washable low-density label to float on the water surface;
(3) washing: transferring the recyclable and readily washable low-density label into the washing solution, raising the temperature to 35-40 °C, stirring for 15-20 minutes, then filtering, washing, and drying to realize the recovery of the recyclable and readily washable low-density label.

9. The recovery method for the recyclable and readily washable low-density label according to claim 8, wherein the surfactant in step (2) is selected from one of ethylene-bis(dodecyldimethylammonium chloride), propylene-bis(hexadecyldimethylammonium bromide), or ethylene-bis(octadecyldimethylammonium chloride); the surfactant is added in an amount of 0.3-1 wt % based on the mass of water.

10. The recovery method for the recyclable and readily washable low-density label according to claim 8, wherein the washing solution in step (3) is prepared by mixing ethyl acetate, pentaerythritol, cocamidopropyl betaine, triethanolamine, and deionized water.
